(19) United States
(12) Patent Application Publication
(10) Pub. No.: US 2008/0130920 A1
(43) Pub. Date: Jun. 5, 2008

(54) CAPACITOR MICROPHONE MANUFACTURING METHOD AND CAPACITOR MICROPHONE

(75) Inventors: Kentaro YONEHARA, Shizuoka-shi (JP); Yasunori TSUKUDA, Shizuoka-shi (JP); Norihiro SAWAMOTO, Shizuoka-shi (JP)

Correspondence Address: SUGHRUE-265550, 2100 PENNSYLVANIA AVE. NW, WASHINGTON, DC, 20037-3213, US

(73) Assignee: STAR MICRONICS CO., LTD., Shizuoka-shi (JP)

(21) Appl. No.: 11/948,446

(22) Filed: Nov. 30, 2007

(30) Foreign Application Priority Data
Nov. 30, 2006 (JP) 2006-324688

(51) Int. Cl. H04R 25/00; H01G 5/16

(52) U.S. Cl. 381/174; 29/25.41

(57) ABSTRACT

A capacitor microphone includes: a circuit substrate; a casing substrate fixed to an upper surface of the circuit substrate; a top cover substrate fixed to the upper surface; a capacitor part including a vibration film and a plate contained in the casing substrate; an impedance conversion element for converting variations in the electrostatic capacity of the capacitor part to electrical impedance; an electromagnetic shield portion electromagnetically shielding an inside of the casing substrate, the electromagnetic shield portion being formed in an outer surface of the casing substrate; a non-electromagnetic shield portion having no electromagnetic shield portion, the non-electromagnetic shield portion being formed in an outer surface of the casing substrate; and a through hole having a conductive property, the through hole being formed in the non-electromagnetic shield portion, wherein the inside of the casing substrate is shielded electromagnetically by the electromagnetic shield portion and the through hole.

### CROSS REFERENCE TO RELATED APPLICATION

This application claims priority from a Japanese Patent Application No. 2006-324688 filed on Nov. 30, 2006, the entire subject matter of which is incorporated herein by reference.

### TECHNICAL FIELD

The present invention relates to a method for manufacturing a capacitor microphone for use in equipment such as a cellular phone, a video camera and a personal computer, as well as to a capacitor microphone.

### BACKGROUND

A conventional capacitor microphone is composed of a cylindrical-shaped metal case such as a can-shaped aluminum case having sound holes and composing parts stored in the metal case. For example, within the metal case, as a lower-most part, there is disposed a circuit substrate and, on the upper surface of this circuit substrate, there is mounted electric equipment such as a field effect transistor. And, upwardly of the circuit substrate, there is mounted a back plate which is held by and between a pair of spacers; and, on the upper-most portion within the metal case, there is disposed a vibration film support frame to the lower surface of which there is connected a vibration film such as a metal thin plate. And, the lower end of the metal case is caulked and closed to the lower surface of the circuit substrate. The metal case is structured such that it has function of electromagnetically shielding the capacitor microphone. In the above-mentioned conventional capacitor microphone, however, there is found a problem that the number of parts is large, the assembling productivity thereof is low and thus the manufacturing cost thereof is high.

To solve this problem, there has been proposed a technology in which a capacitor microphone is manufactured using the following method, as disclosed in JP-A-2002-345092. According to this manufacturing method, for each of a circuit substrate with electric equipment such as a field effect transistor mounted thereon, a back plate substrate, a spacer and a casing substrate for bonding a vibration film thereto, there is prepared a sheet-shaped aggregate member in which a large number of parts are arranged lengthwise and crosswise and are connected integrally to each other; and, these parts are superimposed on top of each other and connected together as they are in their respective congregate members. In the thus obtained superimposed aggregates, there are connected a large number of capacitor microphones in a lattice manner, while each capacitor microphone includes superimposed parts. And, by dicing up these congregate members along the boundary lines between the respective product areas using a cutter, the respective divided pieces can be obtained as capacitor microphones. According to this manufacturing method, a large number of products can be obtained at a time.

### SUMMARY

Here, when the capacitor microphones are made of the aggregate members in the above-mentioned manner, it is necessary to shield electromagnetically the circuits of electrical equipment and the like mounted within the casing substrate. In this case, for example, when each capacitor microphone (product) has a quadrangle shape, in an aggregate member for forming a casing substrate, more specifically, in each of the four sides of each casing substrate, except for its connecting portion for connecting it to its adjoining casing substrate area, there can be formed an elongated-hole-shaped through hole and the inner surface of such through hole can be covered with an electrically conductive member such as copper foil. Owing to provision of the conductive member such as copper foil within the through hole, there can be expected an electromagnetic shield effect.

However, when, as described above, the aggregate members for forming the casing substrates are superimposed on top of each other and the connection portions are diced along the through holes portions thereof using a cutter, the conductive member for electromagnetic shielding is not present in the portion that was the connecting portion (former connecting portion). In this case, there is a problem that electromagnetic noise can enter from the conductive-member-less portion (former connecting portion), can affect the circuit characteristics and can cause the capacitor microphone to generate noise.

It is an object of the invention to provide a capacitor microphone manufacturing method and a capacitor microphone in which, in the non-electromagnetic-shield portion of a casing substrate including no electromagnetic shield portion in the outer surface of a connecting portion as well, specifically, in the side wall of the casing substrate, there is formed a conductive through hole, thereby being able to enhance the electromagnetic shield property of the capacitor microphone.

In attaining the above object, according to a first aspect of the invention, there is provided a capacitor microphone including: a circuit substrate; a casing substrate fixed to an upper surface of the circuit substrate; a top cover substrate fixed to the upper surface of the casing substrate; a capacitor part including a vibration film and a plate contained in the casing substrate so disposed as to face each other; an impedance conversion element for converting variations in the electrostatic capacity of the capacitor part to electrical impedance; an electromagnetic shield portion electromagnetically shielding an inside of the casing substrate, the electromagnetic shield portion being formed in an outer surface of the casing substrate; a non-electromagnetic shield portion having no electromagnetic shield portion, the non-electromagnetic shield portion being formed in an outer surface of the casing substrate; and a through hole having a conductive property, the through hole being formed in the non-electromagnetic shield portion, wherein the inside of the casing substrate is shielded electromagnetically by the electromagnetic shield portion and the through hole.

According to the invention, the non-electromagnetic shield portion includes a through hole having a conductive property formed therein, and the inside of the casing substrate is shielded electromagnetically by the electromagnetic shield portion and the through hole having the conductive property, thereby being able to enhance the electromagnetic shield property of the capacitor microphone.

According to a second aspect of the invention according to the first aspect of the invention, a metal layer is fixedly secured to an inside of the through hole.

Therefore, the conductive property of the through hole can be obtained due to provision of the metal layer in the inside of the through hole, which can electrically shield the inside of the casing substrate and thus can enhance the electromagnetic shield property of the capacitor microphone.

According to a third aspect of the invention according to the first or the second aspect of the invention, a conductive filler is filled into an inside of the through hole.

Therefore, the conductive property of the through hole can be obtained due to filling of the conductive filler into the inside of the through hole, which can electrically shield the inside of the casing substrate and thus can enhance the electromagnetic shield property of the capacitor microphone.

According to a fourth aspect of the invention according to any one of the first to the third aspect of the invention, the through hole is electrically connected to a ground terminal provided on the circuit substrate.

Therefore, since the conductive through hole is electrically connected to a ground terminal provided on the circuit substrate, the inside of the casing substrate is electromagnetically shielded, whereby the electromagnetic shield property of the capacitor microphone can be enhanced.

According to a fifth aspect of the invention, there is provided A method for manufacturing a capacitor microphone, the capacitor microphone including a capacitor part, an impedance conversion element for converting variations in the electrostatic capacity of the capacitor part to electric impedance, and a casing for storing therein the capacitor part and impedance conversion element, the casing including a circuit substrate for mounting the impedance conversion element thereon, a casing substrate including a pair of openings and having a peripheral edge of one of the openings connected to the circuit substrate to thereby enclose the impedance conversion element, and a top cover substrate to be connected to the peripheral edge of the other opening of the casing substrate, the method including: forming hole portions in peripheries of such portions of a casing substrate aggregate sheet that respectively provide casing substrates except for connecting portions; arranging lengthwise and crosswise the casing substrates providing portions, and connecting the casing substrates providing portions to each other through the associated connecting portions; forming through holes in the connecting portions respectively; forming conductive patterns and conductive layers in an inner surfaces of the hole portions and in the through holes; superimposing a circuit substrate aggregate sheet with the circuit substrates arranged lengthwise and crosswise thereon and a top cover substrate aggregate sheet with the top cover substrates arranged lengthwise and crosswise thereon on the casing substrate aggregate sheet, thereby producing an assembly; and cutting the assembly along the peripheries of the casing substrates providing portions to thereby divide the casing into individual capacitor microphones.

According to this aspect of the invention, when the casing is produced (when the casing substrate aggregate sheet is cut along the peripheries of the portions that provide the casing substrates), the surfaces cut by the connecting portions provide non-electromagnetic shield portions; but, in the connecting portions, there are formed through holes which respectively include conductive layers. Also, as regards the hole portions wherein the conductive patterns formed, when the casing is produced (when the casing substrate aggregate sheet is cut along the peripheries of the casing substrates providing portions), the inner surface thereof provides the outer surface of the casing and this portion provides an electromagnetic shield portion. Therefore, in the capacitor microphone manufactured according to the manufacturing method of the invention, in the non-electromagnetic shield portion, there is formed a through hole having a conductive property and thus the inside of the casing substrate is shielded electromagnetically by the electromagnetic shield portion and the through hole having the conductive property, thereby being able to enhance the electromagnetic shield property of the capacitor microphone.

As described above, according to the invention, there can be provided an effect that in the non-electromagnetic-shield portion of a casing substrate including no electromagnetic shield portion in the outer surface of a connecting portion as well, specifically, in the side wall of the casing substrate, there is formed a conductive through hole, thereby being able to enhance the electromagnetic shield property of the capacitor microphone.

### BRIEF DESCRIPTION OF THE DRAWINGS

In the accompanying drawings:

FIG. 1 is a section view of a capacitor microphone according to an embodiment of the invention;

FIG. 2 is an exploded perspective view of the capacitor microphone shown in FIG. 1;

FIG. 3 is an explanatory view of the position relationship between a conductive pattern and a resist on the surface of a circuit substrate;

FIG. 4A is a plan view of a conductive pattern provided on the front surface of a circuit substrate;

FIG. 4B is a plan view of a conductive pattern.

FIG. 4C is a plan view of a conductive pattern provided on the back surface of a circuit substrate;

FIG. 5 is a plan view of a casing base frame;

FIG. 6A is a section view taken along the A-A line shown in FIG. 5;

FIG. 6B is a section view taken along the B-B line shown in FIG. 5;

FIG. 7 is an exploded perspective view of members used in manufacturing a capacitor microphone;

FIGS. 8A to 8E are explanatory views of a process for forming a hole portion and its peripheral portion in a capacitor microphone;

FIG. 9 is a plan view of a casing base frame according to another embodiment of the invention; and

FIG. 10 is a plan view of an aggregate member of a casing base frame according to another embodiment of the invention.

### DETAILED DESCRIPTION

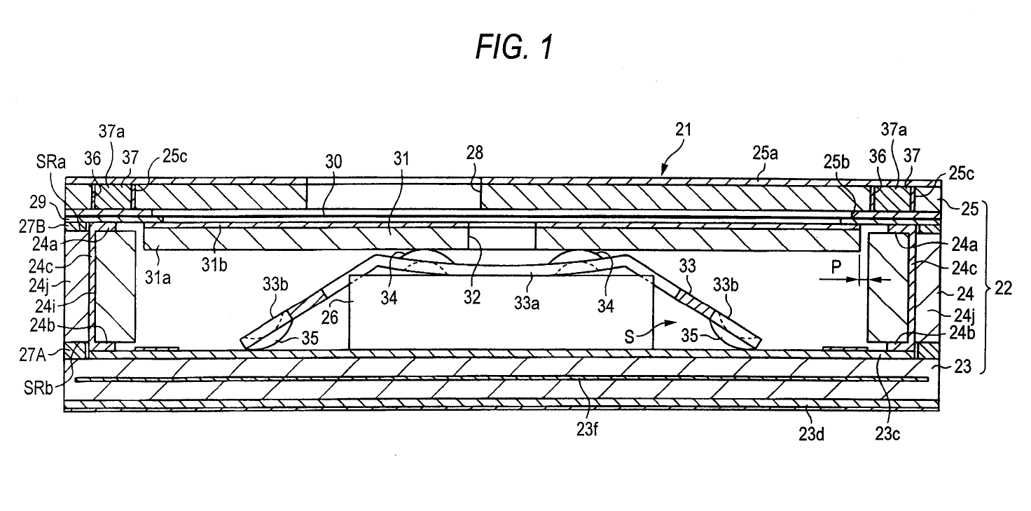

Now, description will be given below of embodiments according to the invention with reference to FIGS. 1 to 8E.

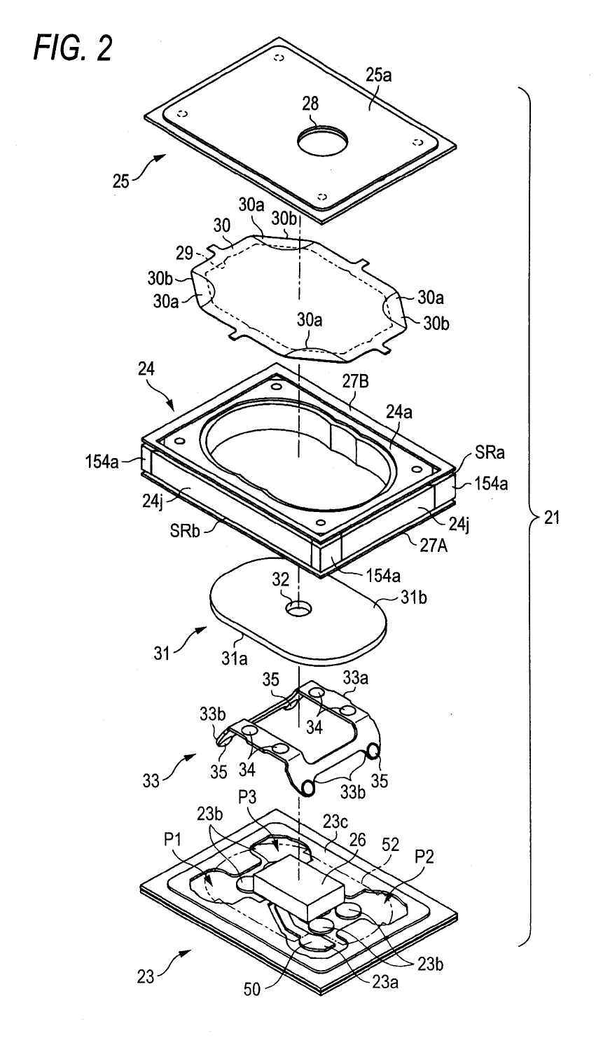

As shown in FIGS. 1 and 2, the casing 22 of a capacitor microphone 21 according to the present embodiment is structured such that a flat-plate-shaped circuit substrate 23 functioning as a mounting substrate, a quadrangle-shaped casing base frame 24 functioning as a casing substrate, and a flat-plate-shaped top cover substrate 25 functioning as a top cover are sequentially superimposed on top of each other, while they are fixed together by adhesive sheets 27A and 27B into an integral body. The circuit substrate 23, casing base frame 24 and top cover substrate 25 are respectively composed of an electrical insulating member which is made of resin such as epoxy resin. According to the present embodiment, the above-mentioned members are respectively made of epoxy resin with glass cloth as a base member thereof. However, the material of these members is not limited to epoxy resin.

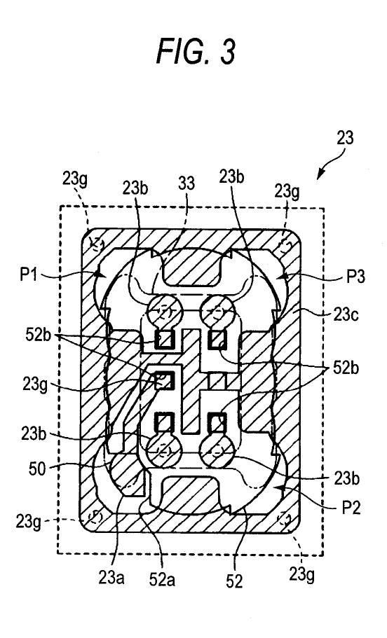

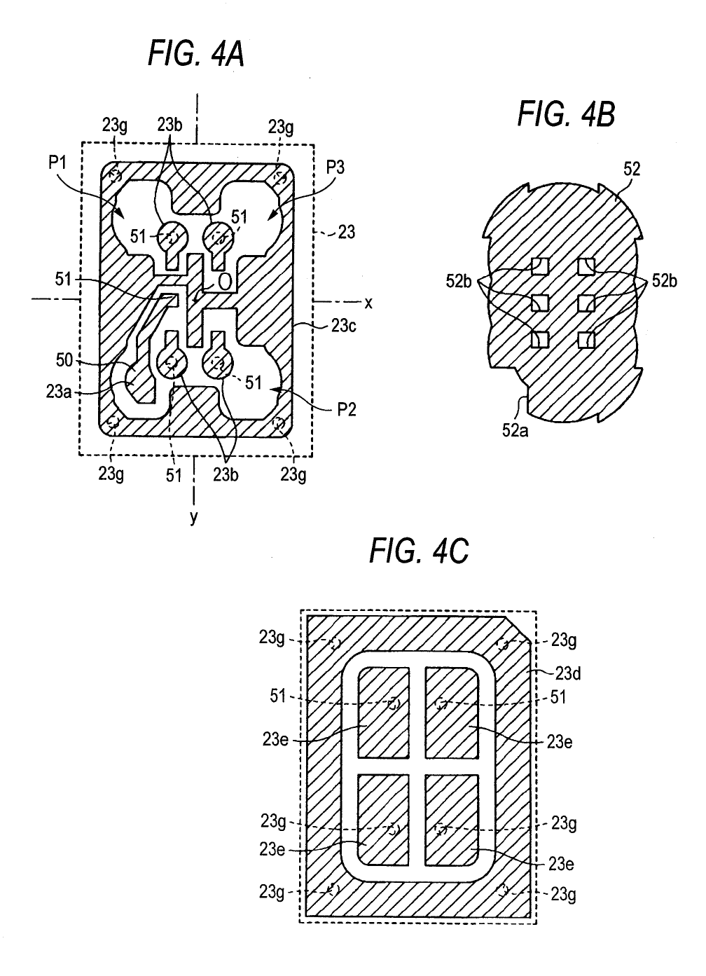

As shown in FIG. 4A, on the upper surface (which is also called the top surface) of the circuit substrate 23, there are formed conductive patterns 23a, 23b and 23c which are respectively made of copper foil and function as conductive members. By the way, in FIGS. 3 and 4A, for convenience of explanation, the conductive patterns 23a, 23b and 23c are shown by hatchings respectively.

As shown in FIG. 4A, the conductive pattern 23a is formed such that its first end portion, on the upper surface of the circuit substrate 23, is situated near to one end portion of the circuit substrate 23 in the longitudinal direction thereof and also near to one side end portion thereof in the lateral direction thereof, while its second end portion 51 is extended toward the central portion of the circuit substrate 23 on the upper surface thereof. And, the first end portion of the conductive pattern 23a is used as a conductive portion 50.

Here, on the upper surface of the circuit substrate 23, a lateral direction axis and a longitudinal direction axis, which are respectively perpendicular to a center axis O (see FIG. 4A) penetrating the circuit substrate 23 in the thickness direction thereof, are respectively referred to as an X axis and a Y axis.

And, on the upper surface of the circuit substrate 23, an area P1 having axial symmetry with respect to the conductive portion 50 with the x axis as an axis of symmetry, an area P2 having axial symmetry with respect to the conductive portion 50 with the y axis as an axis of symmetry, and an area P3 having radial symmetry with respect to the conductive portion 50 with the center axis O as a center point are respectively contained in an area where no conductive pattern is provided (which is hereinafter referred to as a non-conductive pattern area). Here, the term “non-conductive pattern area” means an area that, on the upper surface of the circuit substrate 23, is enclosed by the conductive pattern 23c but excludes the conductive patterns 23a and 23b. The conductive pattern 23b, according to the present embodiment, is provided two or more in number (specifically, there are provided four conductive patterns 23b in the present embodiment).

The conductive pattern 23c, which is a conductive pattern for grounding, is formed in a frame-like shape so that it can correspond to the frame shape of the casing base frame 24. The conductive patterns 23a and 23b are conductive patterns which are used connect parts together and can be used to input power supply or take out value signals.

Also, as shown in FIGS. 3 and 4B, in the upper surfaces of some portions of the conductive patterns 23a to 23c and in the non-conductive pattern area, planes containing the areas P1 to P3 are covered with a resist 52. For convenience of explanation, in FIG. 4B, the resist 52 is shown by hatchings.

The resist 52 is made of, for example, epoxy resin which can serve as an insulating material; however, the material of the resist 52 is not limited to epoxy resin but any synthetic resin can also be used provided that it has an insulating property. Also, the resist 52 is formed to have the same film thickness over the entire area thereof (that is, the whole resist containing the areas P1 to P3) and the thickness of the resist 52 is set equal to the thickness of the conductive portion 50. That is, the portions of the resist 52 that are present in the areas P1 to P3 are set equal in height (that is, in thickness) to the conductive portion 50 with the upper surface of the circuit substrate 23 as a reference thereof. The thickness of the conductive portion 50 and resist 52 is normally set in the range of the order of 20 μm to 40 μm. According to the present embodiment, the thickness of the conductive portion 50 and resist 52 is set for 30 μm. In the portion of the resist 52 that exists in the vicinity of the conductive portion 50, there is formed a cutout 52a to thereby expose the conductive portion 50. Also, in the portions of the resist 52 that correspond to the second end portion 51 of the conductive pattern 23a, one-end portions of the respective conductive patterns 23b and a portion of the conductive pattern 23c, there are formed windows 52b respectively to thereby expose these portions through their associated windows 52b.

And, the frame-shaped peripheral portion of the conductive pattern 23c is not covered with the resist 52 but is exposed, while it faces the casing base frame 24.

Also, as shown in FIG. 4C, on the lower surface (which is also referred to as the back surface) of the circuit substrate 23, there are provided two or more conductive patterns 23d, 23e (in FIG. 1, there is shown only one conductive pattern 23d) each of which is made of copper foil. By the way, in FIG. 4C, for convenience of explanation, the conductive patterns 23d, 23e are shown by hatchings.

And, in the circuit substrate 23, there are formed two or more through holes 23g; and, on the inner peripheries of these through holes 23g, there are provided conductive layers (not shown). The conductive pattern 23c is connected to the conductive patterns 23d provided on the lower surface of the circuit substrate 23 through the conductive layers of some of the through holes 23g. A portion of the conductive pattern 23d is used as a grounding terminal.

Also, through the conductive layers of the remaining through holes, the conductive patterns 23a, 23b are connected to the conductive patterns 23e which are to be connected to a signal output terminal (not shown) or a power input terminal (not shown) provided on the lower surface of the circuit substrate 23.

Within the circuit substrate 23, as shown in FIG. 1, there is provided an intermediate layer 23f made of copper foil, while the intermediate layer 23f is electrically connected to the through holes 23g which electrically connect the conductive patterns 23c and 23d to each other.

Also, on the circuit substrate 23, there is mounted a field effect transistor 26 which constitutes an impedance conversion element used as an electric part disposed within the casing 22. The field effect transistor 26 is electrically connected to the second end portion 51 of the conductive pattern 23a and also to the one-end portions of some of the conductive patterns 23b.

The casing base frame 24 includes openings respectively formed in the upper and lower ends thereof and, as shown in FIG. 1, on the upper and lower end faces and side wall outer surfaces thereof, there are provided conductive patterns 24a, 24b, and 24c which are respectively made of copper foils and are disposed continuous with each other. The conductive patterns 24a and 24b, as shown in FIG. 2, are respectively formed in a ring shape with respect to the peripheral edges of the upper and lower openings of the casing base frame 24 (by the way, in FIG. 2, there is shown only the conductive pattern 24a).

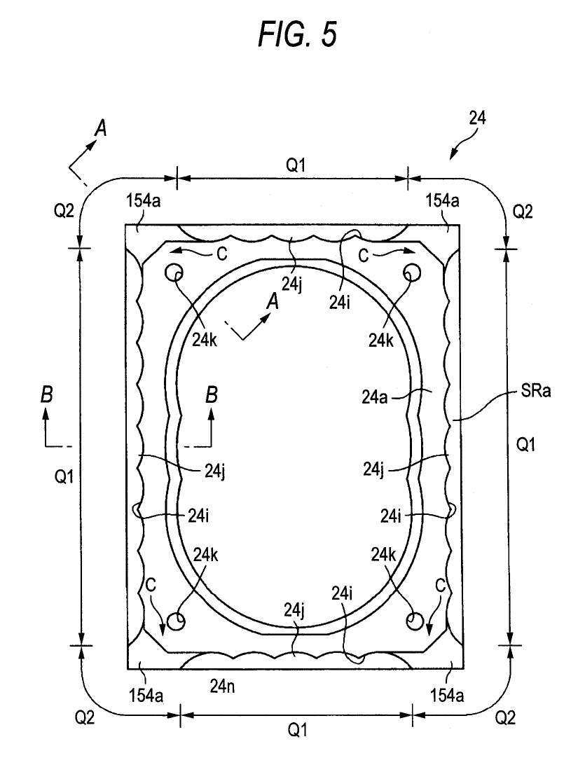

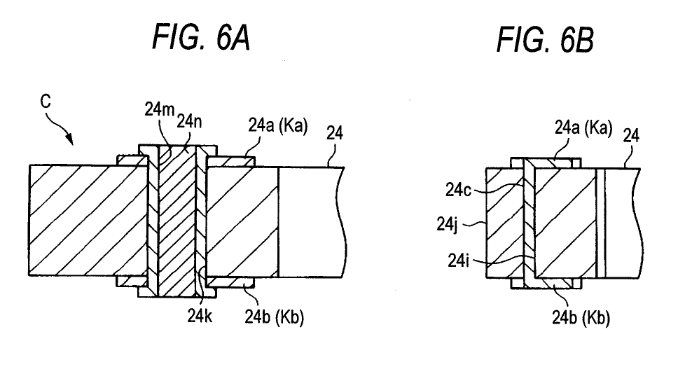

The conductive patterns 24c can be respectively formed by applying a conductive paste to recessed portions 24i, which are respectively formed in the outer surfaces of the side walls of the casing base frame 24 except for the outer surfaces of the four corner portions C of the casing base frame 24, or by plating such recessed portions 24i with metal foil such as copper foil; and, the conductive patterns 24c electrically connect the conductive patterns 24a and 24b to each other (see FIG. 6B). In FIG. 5, reference character Q1 designates the range of the conductive pattern 24c which is provided in the recessed portion 24i of the casing base frame 24. Such provision of the conductive pattern 24c in the recessed portion 24i formed in the side wall outer surface of the casing base frame 24 can realize electromagnetic shield. A portion, where the conductive pattern 24c is provided, corresponds to an electromagnetic shield portion. Also, in the outer surface of the casing base frame 24, as shown in FIG. 5, portions 154a, where the conductive pattern 24c are not provided, are formed in the corner portions C of the casing base frame 24 respectively. The portion 154a not having the conductive pattern 24c constitutes a portion of a connecting portion 154 which is used in connection with a manufacturing method to be discussed later, while the outer surface of the portion 154a corresponds to a non-electromagnetic shield portion. In FIG. 5, reference character Q2 designates the range of the non-electromagnetic shield portion.

Now, the conductive pattern 24b, which is disposed on the lower surface side of the casing base frame 24, as shown in FIG. 1, is connected to the conductive pattern 23d provided on the lower surface of the circuit substrate 23 through the conductive pattern 23c provided on the circuit substrate 23. The recessed portion 24i is filled with insulating synthetic resin such as epoxy resin to thereby form a filled portion 24j (see FIG. 6B).

And, in the casing base frame 24, the upper and lower surfaces of the filled portion 24j cooperate together with the upper and lower surfaces of the portion 154a not having the conductive pattern 24c in forming adhesion areas SRa and SRb each having a substantially quadrangular frame shape. By the way, in FIG. 5, there is shown only the adhesion area SRa that is formed in the upper surface of the casing base frame 24. The adhesion area is not limited to the quadrangular frame shape, but may also have any other shape provided that it is analogous to the frame shape of the casing base frame 24.

And, as shown in FIGS. 2, 5 and 6A, in the four corner portions C of the casing base frame 24, there are respectively formed through holes 24k each having a circular-shaped section. The positions where the through holes 24k are formed, as shown in FIG. 5, are the positions of the corner portions C that exist in the ranges Q2 where the conductive patterns 24c are not provided. And, as shown in FIG. 6A, on the inner periphery of the through hole 24k, there is provided a conductive layer 24m formed as a metal layer in such a manner that it is fixedly secured to such inner periphery. The conductive layer 24m is made of, for example, a metal foil plating such as a copper foil plating and is used to electrically connect the conductive patterns 24a and 24b to each other. In the present embodiment, one through hole 24k is formed in each corner portion C; however, the number of the through holes 24k is not limitative. Also, according to the present embodiment, the shape of the section of the through hole 24k is a circular shape, but it is not limited to the circular shape, for example, it may also be an elongated hole shape. By the way, when the section shape of the through hole 24k is set for the circular shape, preferably, the circular shape of the section of the through hole 24k may have a large diameter, because the circular shape having a large diameter is able to cover a relatively large area of the range Q2 not having the conductive pattern 24c. That is, in the case of the conductive layer 24m as well which is formed in the through hole 24k, when the section shape of the through hole 24k is set for the circular shape, preferably, the circular shape of the section of the through hole 24k may have a large diameter, because the larger the diameter is, the more the conductive layer can cover the range Q2 not having the conductive pattern 24c, thereby being able to enhance the electromagnetic shield effect. Also, the through hole 24k is filled with a conductive paste 24n used as a conductive filler. In order to prevent an electromagnetic wave from moving into the inner periphery of the casing base frame 24 through the range Q2 not having the conductive pattern 24c from the outer surface of the casing base frame 24, preferably, the size and position of the conductive pattern 24c may be set properly.

As shown in FIGS. 1 and 2, the peripheral edge of the lower opening of the casing base frame 24, that is, the adhesion area SRb is integrally adhered and fixed to the circuit substrate 23 by a quadrangular ring-shaped adhesive sheet 27A which is disposed outwardly of the conductive pattern 23c. And, the electric part provided on the circuit substrate 23 such as the field effect transistor 26 is stored into and disposed within the casing base frame 24.

As shown in FIG. 1, on the upper and lower surfaces of the top cover substrate 25, there are provided conductive patterns 25a and 25b each of which is made of copper foil or the like. In the top cover substrate 25, there is formed a sound hole 28 which is used to take in sounds from outside.

As shown in FIGS. 1 and 2, the peripheral edge of the upper opening of the casing base frame 24, that is, the adhesion area SRa is integrally adhered and fixed to the top cover substrate 25 by a quadrangular ring-shaped adhesive sheet 27B which is disposed outwardly of the conductive pattern 24a. In this manner, the peripheral edge of the upper opening of the casing base frame 24 is integrally connected to the top cover substrate 25 through a spacer 29 and a vibration film 30.

As shown in FIGS. 1 and 2, between the casing base frame 24 and top cover substrate 25, there is held and fixed the ring-shaped spacer 29 which is made of an insulating film. Also, the spacer 29 is bonded to the conductive pattern 24a by a conductive adhesive. On the upper surface of the spacer 29, there is provided by adhesion the vibration film 30 which is made of an insulating synthetic resin thin film such as a PPS (polyphenylene sulfide) film; and, on the lower surface of the vibration film 30, there is provided a conductive layer 30a which is formed by gold deposition.

In the vibration film 30 and spacer 29, there are formed through holes (not shown) respectively. The conductive layer 30a can be electrically connected to the conductive pattern 24a through a conductive paste filled into these through holes and also through a conductive adhesive (not shown) interposed between the spacer 29 and casing base frame 24 (accurately, between the spacer 29 and conductive pattern 24a).

As shown in FIG. 1, in the top cover substrate 25, there are formed two or more through holes 36 and, on the inner peripheral surfaces of these through holes 36, there are provided conductive patterns 25c which are respectively continuous with the conductive patterns 25a and 25b. Also, a conductive adhesive 37a is filled into each of the through holes 36, while this conductive adhesive 37a and conductive pattern 25c cooperate together in forming a conductive portion 37. This conductive portion 37 is electrically connected to a conductive layer 30a provided on a turned-back portion 30b (see FIG. 2) which is formed by turning back the lower surface of the vibration film 30. Alternatively, the conductive adhesive 37a may not be filled into the through hole 36, provided that the conductive pattern 25c is provided on the through hole 36. Also, when the conductive pattern 25c is not provided within the through hole 36, the conductive adhesive 37a may only be filled into the through hole 36. However, when the conductive pattern 25c is provided and also conductive adhesive 37a is filled into the through hole 36, the conductive property and shield property of the top cover substrate 25 can be further enhanced.

And, the conductive patterns 25a and 25b of the top cover substrate 25 form a conduction path which leads through the conductive portion 37, conductive layer 30a, conductive pastes filled into the through holes (not shown) formed in the vibration film 30, conductive adhesive interposed between the spacer 29 and conductive pattern 24a, and conductive patterns 24a to 24c provided on the casing base frame 24 to the above-mentioned grounding terminal provided on the circuit substrate 23.

Within the casing base frame 24, there is disposed a back plate 31 functioning as a plate in such a manner that it faces the lower surface of the vibration film 30 with the spacer 29 between them. This back plate 31 is composed of a back plate main body 31a made of a stainless steel plate and a film 31b made of a PTFE (polytetrafluoroethylene) film or the like bonded on the upper face of the back plate main body 31a. On the film 31b, there has been enforced a poling processing using corona discharge or the like and, owing to this poling processing, the film 31b is allowed to constitute an electret layer. In the present embodiment, the back plate 31 constitutes a back pole; and thus, the capacitor microphone according to the present embodiment is structured as a back electret type capacitor microphone.

Further, the back plate 31 is formed such that it has a substantially elliptical-shaped plane shape and also that it has an outer peripheral shape smaller than the inner peripheral shape of the casing base frame 24; and, between the inner peripheral surface of the casing base frame 24 and outer peripheral surface of the back plate 31, there is formed a clearance P. In the central portion of the back plate 31, there is opened up a penetration hole 32 which is used to allow the air to move when the vibration film 30 is vibrating. This back plate 31 can be formed by punching a plate member made of stainless steel with the film 31b bonded thereto from the film 31b side, that is, from the upper side in FIG. 2 toward the lower side in FIG. 2 using a punching blade (not shown).

As shown in FIGS. 1 and 2, within the casing base frame 24, between the back plate 31 and circuit substrate 23, there is a hold member 33 made of a spring member is interposed in a compressed state and, owing to the elastic force of the hold member 33, the back plate 31 is pressurized from the opposite side of the vibration film 30 in a direction where it is contacted with the lower surface of the spacer 29. This keeps a given clearance between the vibration film 30 and back plate 31; and, between them, there is formed a capacitor portion in which there is secured a given level of capacity.

The hold member 33 can be formed by punching a plate member made of a stainless steel plate the front and back surfaces of which are both gold plated; and, the hold member 33 includes a substantially quadrangular ring-shaped frame portion 33a, and four leg portions 33b respectively projecting obliquely from the four corners of the frame portion 33a toward the two lower lateral sides thereof. Therefore, between the portions of the leg portions 33b that exist downwardly of the frame portion 33a, there is formed a space S. And, according to the present embodiment, as shown in FIG. 1, the above-mentioned field effect transistors 26 provided on the circuit substrate 23 are respectively interposed between the respective pairs of leg portions 33b within the space S.

On the upper surface of the frame portion 33a of the hold member 33, there are projectingly provided four contact portions 34 functioning as spherical-shaped projecting portions to be contacted with the lower surface of the back plate 31; and, on the lower surfaces of the leading ends of the respective leg portions 33b, there are projectingly provided four contact portions 35 functioning as spherical-shaped projecting portions.

Of the four leg portions 33b, one leg portion 33b is contacted with a conductive portion 50 through its associated contact portion 35, whereas the remaining leg portions 33b are respectively contacted through their associated contact portions 35 with the portions of the upper surface of the resist 52 respectively situated in areas P1 to P3 contained in the non-conductive pattern area on the upper surface of the circuit substrate 23. The portions of the resist 52 situated in the areas P1 to P3 correspond to the placement portions of the leg portions 33b.

Now, in this capacitor microphone 21, when a sound wave from a sound source arrives at the vibration film 30 through the sound hole 28 of the top cover substrate 25, the vibration film 30 is vibrated according to the frequency, amplitude and waveform of the sound. And, with the vibratory motion of the vibration film 30, a clearance between the vibration film 30 and back plate 31 is caused to vary from its set value, whereby the impedance of the capacitor part is caused to vary. The variation of the impedance is converted into a voltage signal by an impedance conversion element and such voltage signal is then output.

Next, description will be given below of a method for manufacturing the above-structured capacitor microphone 21.

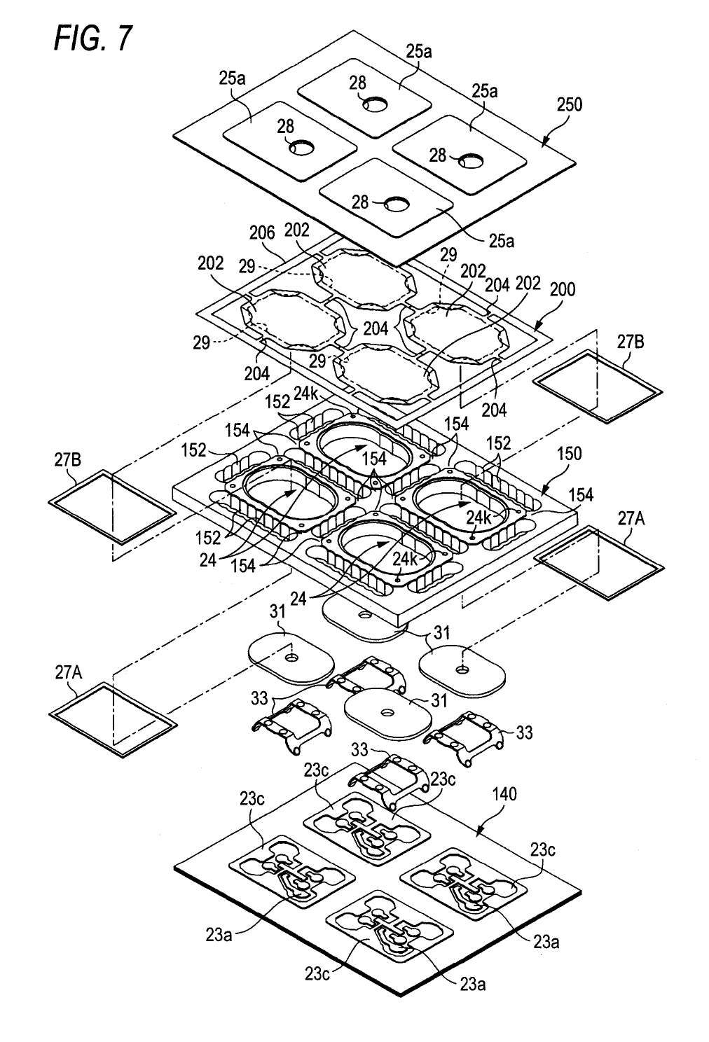

To manufacture the capacitor microphone 21, two or more sheet-shaped aggregate members may be superimposed on top of each other and may be then assembled together and, after then, they may be divided into individual capacitor microphones 21. In this manufacturing method, as shown in FIG. 7, there are manufactured two or more capacitor microphones 21 using a circuit substrate member 140, a casing base frame forming member 150, a vibration film forming member 200, a top cover substrate forming member 250, back plates 31, hold members 33 and the like. Here, the circuit substrate member 140 corresponds to a circuit substrate aggregate sheet. The casing base frame forming member 150 corresponds to a casing substrate aggregate sheet. The top cover substrate forming member 250 corresponds to a top cover substrate aggregate sheet.

The circuit substrate member 140 is an insulating substrate functioning as an aggregate member which is used to produce two or more circuit substrates 23, while the circuit substrate member 140 is formed in a sheet-like shape. On the upper surfaces of the portions of the circuit substrate member 140 that respectively provide the circuit substrates 23, there are provided conductive patterns 23a, 23b and 23c respectively; and, on the lower surfaces of the portions of the circuit substrate member 140 that respectively provide the circuit substrates 23, there are provided conductive patterns 23d, 23e respectively.

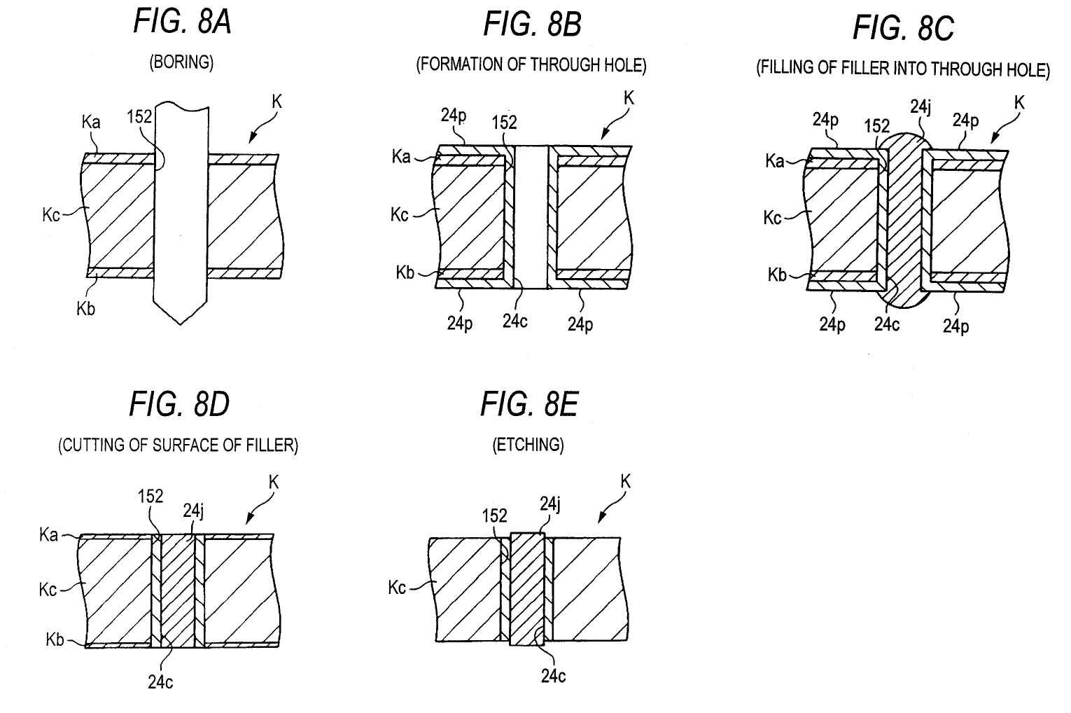

The casing base frame forming member 150 is a plate member functioning as an aggregate member which is used to produce two or more casing base frames 24. Here, description will be given below of a method for manufacturing the casing base frame forming member 150 with reference to FIGS. 8A to 8E.

Firstly, in a double-face substrate K (that is, a printed circuit board) which is composed of an insulating substrate Kc functioning as a core member and conductive patterns Ka, Kb made of copper foil respectively provided on both surfaces of the insulating substrate Kc, a boring operation is enforced not only on between the portions of the double-face substrate K that provide the casing base frames 24 but also on the peripheral edge portion of the double-face substrate K using a router, a drill or the like. Specifically, in the double-face substrate K, there are formed two or more hole portions 152 lengthwise and crosswise at a given pitch (see FIG. 8A). In this operation, in the four corner portions C of the casing base frame 24 as well, through holes 24k are bored and formed using a drill. The through holes 24k may be formed simultaneously when the hole portions 152 are formed, or they may be formed before or after the formation of the hold portions 152.

The hole portions 152 are originally formed as through holes (via holes). However, after execution of a dicing operation which will be discussed later, they provide the recessed portions 24i of the casing base frame 24. The areas of the casing base frame forming member 150 where the hole portions 152 are formed respectively provide the adhesion areas SRa, SRb except for the portions to be diced later.

In FIG. 7, for convenience of explanation, the hole portions 152 are shown in such a manner that the filled portions 24j within the hole portions 152 are omitted. Owing to formation of the hole portions 152, the portions of the casing base frame forming member 150, which provide the respective casing base frames 24, are connected to their mutually adjoining portions through their associated connecting portions 154. Here, the term “the mutually adjoining portions” means that they contain the portions to provide the casing base frames 24 and the peripheral edge portion of the casing base frame forming member 150.

Next, as shown in FIGS. 8B and 6A, when a conductive paste is applied to the inner surface of each hole portion 152 and the inner surface of each through hole k, or when such inner surfaces are plated with metal foil such as copper foil, there are formed a conductive pattern 24c and a conductive layer 24m.

In this case, of the upper and lower surfaces of the portions to provide the casing base frames 24, areas not to provide the adhesion areas SRa, SRb (which, for example, include, in the conductive patterns Ka, Kb of the double-face substrate K, the areas to provide the conductive patterns 24a, 24b) are masked (not shown). The reason for this is, for example, to prevent a new conductive pattern or layer from being formed on the areas to provide the conductive patterns 24a, 24b when the conductive pattern 24c is formed. When the conductive pattern 24c is formed, on the conductive patterns Ka, Kb on the portions not masked, that is, on the portions to constitute part of the adhesion areas SRa, SRb, for example, on the upper and lower surfaces of the connecting portion 154, simultaneously with formation of the conductive pattern 24c, there is formed a conductive pattern 24p which functions as a second metal layer.

Next, as shown in FIG. 8C, after formation of the conductive pattern 24c, insulating synthetic resin such as epoxy resin functioning as a filler, specifically, as a resin filler is filled into the hole portion 152 to thereby form a filled portion 24j. By the way, as the insulating synthetic resin such as epoxy resin, there is selected such synthetic resin as not to react with an etchant which will be discussed later. Also, as shown in FIG. 6A, the conductive paste 24n is filled into the through hole 24k. The filling of the conductive paste 24n may be carried out simultaneously with, or before or after filling of the insulating synthetic resin into the hole portion 152.

Next, as shown in FIG. 8D, of the upper and lower portions of the filled portion 24j, the portions swelling out from the double-face substrate K are cut off to thereby flatten the upper and lower end faces of the filled portion 24j. Also, at the then time, the conductive patterns Ka, Kb are shaved off to the flat end faces of the filled portion 24j. The conductive patterns Ka, Kb may preferably have a thickness of the order of 10 μm to 25 μm.

Next, as shown in FIG. 8E, in a state where the above-mentioned masking has been enforced on the areas to provide the conductive patterns 24a, 24b, the conductive patterns Ka, Kb on the connecting portion 154 are removed using an etchant. As a result of this, no metal layer is present any longer on the upper and lower surfaces of the connecting portion 154 to provide the adhesion areas SRa, SRb as well as on the upper and lower surfaces of the filled portion 24j.

After then, the above-mentioned mask is removed to thereby expose the areas that provide the conductive patterns 24a, 24b. Since the hole portions 152 are formed in this manner, the portions that provide the respective casing base frames 24 are connected to their mutually adjoining portions through their associated connecting portions 154. Here, the term “the mutually adjoining portions” means that they contain the portions to provide the casing base frames 24 and the peripheral edge portion of the casing base frame forming member 150. Also, the through hole 24k is formed in the portion of the casing base frame 24 that faces the portion where the connecting portion 154 has been formed.

Now, the vibration film forming member 200 is a sheet member functioning as an aggregate member in which island members 202 for forming two or more vibration films 30 are disposed lengthwise and crosswise. Also, in the vibration film forming member 200, the respective island members 202 to provide the vibration films 30 are connected to a frame member 206 and to their adjoining island members 202 through their associated connecting portions 204; and, in the corner portions of the island members 202, there are formed turned-back portions 30b respectively. Here, the spacer 29 is connected to the lower surfaces of the respective island members 202. Now, the top cover substrate forming member 250 is a substrate which is used to form two or more top cover substrates 25; and, in the top cover substrate forming member 250, there are formed sound holes 28 and conductive patterns 25a, 25b lengthwise and crosswise with a given pitch.

To manufacture the capacitor microphone 21, in a state where the field effect transistor 26 is previously mounted on the circuit substrate member 140, the circuit substrate member 140 may be bonded to the adhesive area SRb of the casing base frame forming member 150 using a conductive adhesive and an adhesive sheet 27A to thereby unify them. By the way, in FIG. 7, for convenience of explanation, there are shown only some of the adhesive sheets 27A. Actually, however, the adhesive sheet 27A is used in every portion which provides the circuit substrates 23.

Next, into the thus assembled assy., more specifically, into the portions of the assy. that correspond to the casing base frames 24, there are stored the hold members 33 and back plates 31. After then, the vibration film forming member 200 is bonded to the adhesive area SRa of the assy. using a conductive adhesive and an adhesive sheet 27B. At the then time, owing to this conductive adhesive, there are bonded together the conductive patterns 24a and the spacers 29 of the island members 202 existing in such portions that correspond to the casing base frames 24. In FIG. 7, for convenience of explanation, there are shown only some of the adhesive sheets 27B. Actually, however, the adhesive sheet 27B is used in every portion that provides the casing base frame 24.

After then, the top cover substrate forming member 250 is bonded to the assy. with the vibration film forming member 200 superimposed thereon using a conductive adhesive. At the then time, there are bonded together the respective conductive patterns 25b of the top cover substrate forming member 250 and vibration film 30 by the above-mentioned adhesive. By the way, the term “assy”, in which the circuit substrate member 140, casing base frame forming member 150 and top cover substrate forming member 250 are superimposed on top of each other, corresponds to the term “an assembly”. After then, the assy. is diced (cut) along the hole portions 152 using a diamond blade or the like to thereby produce two or more capacitor microphones 21. The cutting operation along the hole portions 152 may preferably be carried out in a half the width of the hole portion 152 (that is, the length of the hole portion 152 in a direction perpendicular to the extending direction of the hole portion 152).

By the way, in FIG. 7, for convenience of explanation, there is shown a state where there are produced four (2×2=4) capacitor microphones 21; however, actually, there are produced hundreds of capacitor microphones 21 at a time.

The present embodiment has the following characteristics.

In a method for manufacturing the capacitor microphone 21 according to the invention, in the peripheries of the portions of the casing base frame forming member 150 (casing substrate aggregate sheet) that provide the casing base frames 24 (casing substrates) except for the connecting portions 154, there are formed the hole portions 152, and the portions to provide the two or more casing base frames 24 are arranged lengthwise and crosswise and are connected to each other through their associated connecting portions 154. Also, in the connecting portions 154, there are formed the through holes 24k respectively. And, on the inner surfaces of the hole portions 152 and in the through holes 24k, there are provided the conductive patterns 24c and conductive layers 24m respectively.

And, on the casing base frame forming member 150 (casing substrate aggregate sheet), there are superimposed not only the circuit substrate member 140 (circuit substrate aggregate sheet) with the circuit substrates 23 arranged lengthwise and crosswise thereon but also the top cover substrate forming member 250 (top cover substrate aggregate sheet) with the top cover substrates 25 arranged lengthwise and crosswise thereon, thereby producing an assembly. After then, the assembly is cut along the peripheries of the portions to provide the casing substrates, specifically, along the hole portions 152, thereby dividing the casing into individual casings. As a result of this, when the casing is produced (that is, when the assembly is cut along the peripheries of the portions to provide the casing substrates), the surfaces cut by the connecting portions 154 respectively provide non-electromagnetic shield portions and the connecting portions 154 respectively come to have the through holes 24k with the conductive layers 24m included therein. Also, as regards the hole portion 152 providing portion of the casing base frame forming member 150, when the casing is produced (that is, the assembly is cut along the peripheries of the portions to provide the casing substrates), the inner surface of the hole portion 152 provides the outer surface of the casing and this casing outer surface portion provides an electromagnetic shield portion (a portion where the conductive pattern 24c is provided). Therefore, in the capacitor microphone 21 manufactured according to the present manufacturing method, the non-electromagnetic shield portion thereof (the portion 154a where the conductive pattern 24c is not provided) includes the through hole 24k having a conductive property, and the interior of the casing substrate is electromagnetically shielded by the electromagnetic shield portion and through hole 24k having a conductive property, thereby being able to enhance the electromagnetic shield property by the casing base frame 24.

The capacitor microphone 21 according to the present embodiment includes, in the outer surface of the casing base frame 24 (casing substrate), an electromagnetic portion (in FIG. 5, a portion shown by the range Q1) and a non-electromagnetic portion where no electromagnetic shield portion is provided (in FIG. 5, a portion shown by the range Q2). And, in the side wall of the casing base frame 24 of the non-electromagnetic portion, there is formed the through hole 24k having a conductive property. And, the interior of the casing base frame 24 is electromagnetically shielded by the electromagnetic shield portion (in FIG. 5, the portion shown by the range Q1) and through hole 24k.

As a result of this, according to the present embodiment, since the interior of the casing base frame 24 is shielded electromagnetically, the electromagnetic shield property of the casing base frame 24 can be enhanced.

In the capacitor microphone 21 according to the present embodiment, the conductive property of the through hole 24k can be obtained due to provision of the conductive layer 24m (metal layer) inside the through hole 24k. Owing to this, the inside of the casing base frame 24 (casing substrate) is electromagnetically shielded, thereby being able to enhance the electromagnetic shield property of the casing base frame 24.

In the capacitor microphone 21 according to the present embodiment, the conductive property of the through hole 24k can be obtained due to the conductive paste 24n (conductive filler) filled into the inside of the through hole 24k. Owing to this, the inside of the casing base frame 24 (casing substrate) is electromagnetically shielded, thereby being able to enhance the electromagnetic shield property of the casing base frame 24.

Also, in the capacitor microphone 21 according to the present embodiment, since the through hole 24k is in conduction with the conductive pattern 23d having a grounding terminal formed in the circuit substrate 23, the inside of the casing base frame 24 (casing substrate) is electromagnetically shielded, thereby being able to enhance the electromagnetic shield property of the casing base frame 24.

Also, in the capacitor microphone 21 according to the present embodiment, in the outer surface of the casing base frame 24, as shown in FIG. 5, the portion 154a, where the conductive pattern 24c is not provided, is formed in the corner portion C of the casing base frame 24. This portion 154a constitutes part of the connecting portion 154 interposed between the portions to provide the casing base frames 24 in the casing base frame forming member 150 at the manufacturing stage of the capacitor microphone 21. Since the recessed portion 24i and conductive pattern 24c are not formed in the portion 154a, the portion 154a is unable to have an electromagnetic shield portion on the outer surface of the casing base frame 24. However, according to the present embodiment, since the conductive through hole 24k is formed in the corner portion C including the portion 154a, the electromagnetic shield property of the casing base frame 24 can be enhanced.

By the way, the present embodiment can also be embodied by changing it in the following manner.

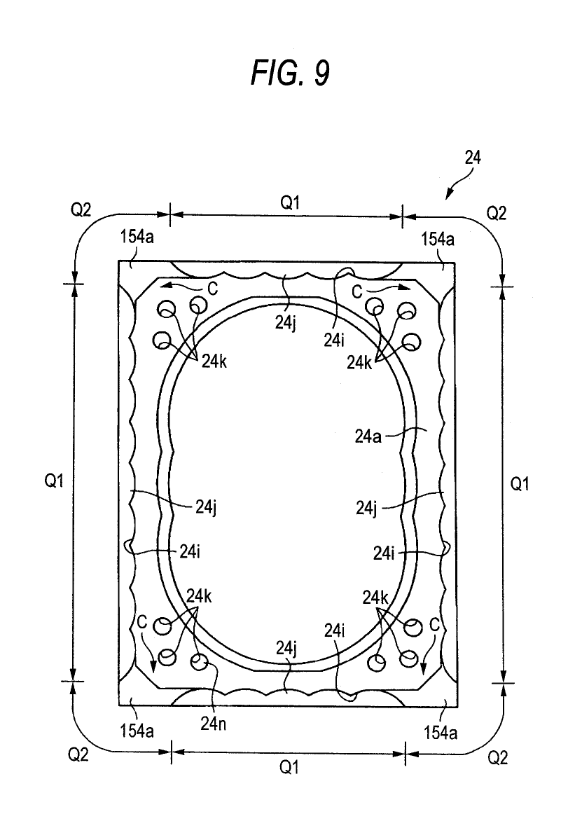

In the above embodiment, the number of through holes 24k is one in each corner portion C. However, as shown in FIG. 9, there may also be formed two or more through holes 24k each having a conductive layer on the inner peripheral surface thereof. In this case, two or more through holes 24k may be formed interspersedly in the corner portion C in the range Q2, or may be superimposed on top of each other.

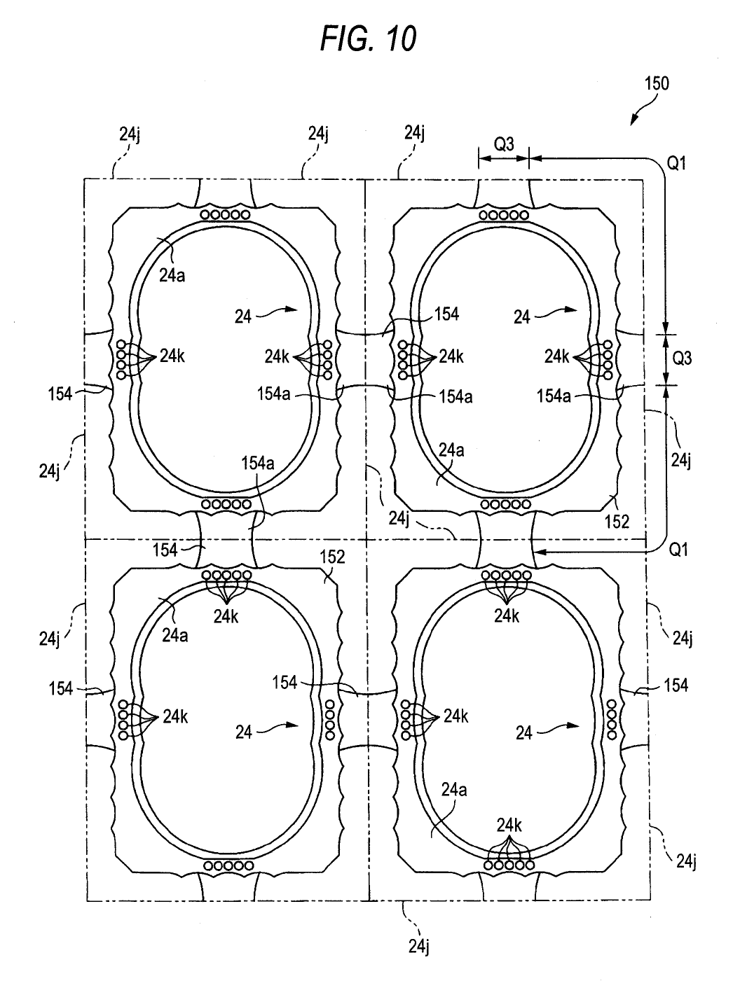

In the above embodiment, in the corner portion C, there is formed the portion 154a which provides part of the connecting portion 154. However, the position of the portion 154a to provide part of the connecting portion 154 is not limited to the corner portion C. For example, as shown in FIG. 10, the portion 154a may also be formed in the central portions of the longitudinal and lateral sides of the four sides of the casing base frame 24, or may also be formed between such central portions and corner portions C. In this case, the conductive through holes 24k may be formed in the side walls of the casing base frame 24 that correspond to the portions 154a.

In FIG. 10, members and portions, which are similar to or equivalent to those employed in the above embodiment, are given the same designations. Also, in the embodiment shown in FIG. 10, the casing base frame forming member 150 is cut in the two-dot chained line portion thereof after insulating synthetic resin such as epoxy resin is filled into the hole portion 152 to thereby form the filled portion 24j.

In the above embodiment, the back plate main body 31a is made of a stainless steel plate. However, the back plate main body 31a may also be made of a brass plate, a titanium plate or the like.

The invention may also be embodied in a capacitor microphone of a foil electret type in which the vibration film 30 is made of a macro molecule film for an electret.

Also, in the above embodiment, description has been given of an electret capacitor microphone of a back electret type. However, the invention may also be applied to an electret capacitor microphone of a front electret type.

The invention may also be embodied in a capacitor microphone of a charge pump type including a booster circuit. In this case, instead of an electret layer, there are disposed respectively, in the vibration film 30 and back plate 31, electrodes which face each other.

The impedance conversion element mounted on the circuit substrate 23 according to the above embodiment is just an example. There can also be used a well-known element which employs either analog or digital operation method, provided that it can detect a variation in the electrostatic capacity of the capacitor part.

In the above embodiment, the conductive paste 24n is filled into the through hole 24k as a conductive filler. However, the conductive paste 24n may be omitted and only the conductive layer 24m may be formed within the through hole 24k as a metal layer.

In the above embodiment, the conductive layer 24m of the through hole 24k may be omitted and the conductive paste 24n may be filled into the through hole 24k as a conductive filler.

The invention is not limited to a capacitor microphone in which, as in the above embodiment, its capacitor part is composed of the spacer 29, vibration film 30, back plate 31 and the like. But, the invention can also be applied to a capacitor microphone in which its capacitor part is structured according to a MEMS (Micro Electro Mechanical System) technology.

What is claimed is:

1. A capacitor microphone comprising:
a circuit substrate;
a casing substrate fixed to an upper surface of the circuit substrate;
a top cover substrate fixed to the upper surface of the casing substrate;
a capacitor part including a vibration film and a plate contained in the casing substrate so disposed as to face each other;
an impedance conversion element for converting variations in the electrostatic capacity of the capacitor part to electrical impedance;
an electromagnetic shield portion electromagnetically shielding an inside of the casing substrate, the electromagnetic shield portion being formed in an outer surface of the casing substrate;
a non-electromagnetic shield portion having no electromagnetic shield portion, the non-electromagnetic shield portion being formed in an outer surface of the casing substrate; and
a through hole having a conductive property, the through hole being formed in the non-electromagnetic shield portion, wherein
the inside of the casing substrate is shielded electromagnetically by the electromagnetic shield portion and the through hole.

2. The capacitor microphone according to claim 1, wherein
a metal layer is fixedly secured to an inside of the through hole.

3. The capacitor microphone according to claim 1, wherein
a conductive filler is filled into an inside of the through hole.

4. The capacitor microphone according to claim 2, wherein
a conductive filler is filled into the inside of the through hole.

5. The capacitor microphone according to claim 1, wherein
the electromagnetic through hole is electrically connected to a ground terminal provided on the circuit substrate.

6. The capacitor microphone according to claim 2, wherein
the electromagnetic through hole is electrically connected to a ground terminal provided on the circuit substrate.

7. The capacitor microphone according to claim 3, wherein
the electromagnetic through hole is electrically connected to a ground terminal provided on the circuit substrate.

8. A method for manufacturing a capacitor microphone, the capacitor microphone including a capacitor part, an impedance conversion element for converting variations in the electrostatic capacity of the capacitor part to electric impedance, and a casing for storing therein the capacitor part and impedance conversion element, the casing including a circuit substrate for mounting the impedance conversion element thereon, a casing substrate including a pair of openings and having a peripheral edge of one of the openings connected to the circuit substrate to thereby enclose the impedance conversion element, and a top cover substrate to be connected to the peripheral edge of the other opening of the casing substrate, the method comprising:
forming hole portions in peripheries of such portions of a casing substrate aggregate sheet that respectively provide casing substrates except for connecting portions;
arranging lengthwise and crosswise the casing substrates providing portions, and connecting the casing substrates providing portions to each other through the associated connecting portions;
forming through holes in the connecting portions respectively;
forming conductive patterns and conductive layers in an inner surfaces of the hole portions and in the through holes;
superimposing a circuit substrate aggregate sheet with the circuit substrates arranged lengthwise and crosswise thereon and a top cover substrate aggregate sheet with the top cover substrates arranged lengthwise and crosswise thereon on the casing substrate aggregate sheet, thereby producing an assembly; and
cutting the assembly along the peripheries of the casing substrates providing portions to thereby divide the casing into individual capacitor microphones.
